(19) United States
(12) Patent Application Publication
(10) Pub. No.: US 2025/0370824 A1
(43) Pub. Date: Dec. 4, 2025

(54) APPARATUSES, SYSTEMS, AND METHODS FOR ALLOCATION AND BALANCING OF CPU RESOURCES IN VIRTUALIZED COMPUTING ENVIRONMENTS

(71) Applicants: Jaishankar RAJENDRAN, Bangalore (IN); Aravindan MUTHUKUMAR, Tuticorin (IN); Vaibhav SHANKAR, Lake Stevens, WA (US); Rajshree CHABUKSWAR, Sunnyvale, CA (US); Prashant KODALI, Portland, OR (US); Satwik KARRA, Rajahmundry (IN)

(72) Inventors: Jaishankar RAJENDRAN, Bangalore (IN); Aravindan MUTHUKUMAR, Tuticorin (IN); Vaibhav SHANKAR, Lake Stevens, WA (US); Rajshree CHABUKSWAR, Sunnyvale, CA (US); Prashant KODALI, Portland, OR (US); Satwik KARRA, Rajahmundry (IN)

(21) Appl. No.: 19/224,410

(22) Filed: May 30, 2025

Related U.S. Application Data
(60) Provisional application No. 63/654,121, filed on May 31, 2024.

(51) Int. Cl. G06F 9/50

(52) U.S. Cl. CPC G06F 9/5083; G06F 9/5044; G06F 9/505; G06F 2209/5021

(57) ABSTRACT

Some aspects of the present disclosure relate to an apparatus comprising interface circuitry, machine-readable instructions and processing circuitry to execute the machine-readable instructions to allocate a plurality of virtual processors to a virtual machine, VM, wherein the VM is executing a workload and running on a host, the host comprising a processing circuitry comprising a plurality of processing cores of a first performance category and a plurality of processing cores of a second performance category. Further, the machine-readable instructions and processing circuitry are to assign each of the plurality of virtual processors either to a processing core of the first performance category or to a processing core of the second performance category. Further, the machine-readable instructions and processing circuitry are to dynamically re-assign at least one of the virtual processors assigned to a processing core of the second performance category to a processing core of first performance category, based on a measurement of the virtual machine and/or on a measurement of the host running the VM.

### CROSS-REFERENCE TO RELATED APPLICATION

This application claims priority to US Provisional Application 63/654,121, filed on May 31, 2024. The content of this earlier filed application is incorporated by reference.

### BACKGROUND

Modern processors, such as central processing units (CPUs), often feature a hybrid architecture that combines performance-oriented cores and efficiency-oriented cores, enhancing the overall user experience. Performance cores are designed to boost performance for complex workloads with limited threading, while efficiency cores are optimized for multi-threaded throughput and scenarios where power efficiency is crucial.

In a setup with multiple virtual machines (multi-VM), the effectiveness of the virtual-CPU-to-physical-CPU (vCPU-to-pCPU) ratio varies by application. Multiple vCPUs enhance parallelizable workloads but can hinder performance for non-multithreaded applications. For example, a VM with four vCPUs needs the hypervisor to allocate four pCPUs simultaneously, complicating resource allocation when another VM on the same platform also seeks pCPUs, especially for single-threaded tasks. Thus, VMs compete for the same physical resources; therefore, there is a need for an improved method to allocate and balance CPU resources for VMs.

### BRIEF DESCRIPTION OF THE FIGURES

Some examples of apparatuses and/or methods will be described in the following by way of example only, and with reference to the accompanying figures, in which

FIG. 1 illustrates a block diagram of an example of an apparatus;

FIG. 2 illustrates a high-level flow diagram of the proposed technique;

FIG. 3 illustrates an example of a Bayesian model with probability tables;

FIG. 4 illustrates an example of results of the proposed technique; and

FIG. 5 shows a flowchart of a method for allocating and balancing CPU resources for VMs.

### DETAILED DESCRIPTION

Some examples are now described in more detail with reference to the enclosed figures. However, other possible examples are not limited to the features of these embodiments described in detail. Other examples may include modifications of the features as well as equivalents and alternatives to the features. Furthermore, the terminology used herein to describe certain examples should not be restrictive of further possible examples.

Throughout the description of the figures same or similar reference numerals refer to same or similar elements and/or features, which may be identical or implemented in a modified form while providing the same or a similar function. The thickness of lines, layers, and/or areas in the figures may also be exaggerated for clarification.

When two elements, A and B, are combined using an “or,” this is to be understood as disclosing all possible combinations, i.e., only A, only B, as well as A and B, unless expressly defined otherwise in the individual case. As an alternative wording for the same combinations, “at least one of A and B,” or “A and/or B” may be used. This applies equivalently to combinations of more than two elements.

If a singular form, such as “a,” “an,” or “the,” is used and the use of only a single element is not defined as mandatory either explicitly or implicitly, further examples may also use several elements to implement the same function. If a function is described below as implemented using multiple elements, further examples may implement the same function using a single element or a single processing entity. It is further understood that the terms “include,” “including,” “comprise,” and/or “comprising,” when used, describe the presence of the specified features, integers, steps, operations, processes, elements, components, and/or a group thereof, but do not exclude the presence or addition of one or more other features, integers, steps, operations, processes, elements, components and/or a group thereof.

In the following description, specific details are set forth, but examples of the technologies described herein may be practiced without these specific details. Well-known circuits, structures, and techniques have not been shown in detail to avoid obscuring an understanding of this description. “An example/example,” “various examples/examples,” “some examples/examples,” and the like may include features, structures, or characteristics, but not every example necessarily includes the particular features, structures, or characteristics.

Some examples are now described in more detail with reference to the enclosed figures. However, other possible examples are not limited to the features of these embodiments described in detail. Other examples may include modifications of the features as well as equivalents and alternatives to the features. Furthermore, the terminology used herein to describe certain examples should not be restrictive of further possible examples.

Throughout the description of the figures, same or similar reference numerals refer to same or similar elements and/or features, which may be identical or implemented in a modified form while providing the same or a similar function. The thickness of lines, layers, and/or areas in the figures may also be exaggerated for clarification.

When two elements A and B are combined using an “or,” this is to be understood as disclosing all possible combinations, i.e., only A, only B as well as A and B, unless expressly defined otherwise in the individual case. As an alternative wording for the same combinations, “at least one of A and B” or “A and/or B” may be used. This applies equivalently to combinations of more than two elements.

If a singular form, such as “a,” “an,” and “the” is used and the use of only a single element is not defined as mandatory either explicitly or implicitly, further examples may also use several elements to implement the same function. If a function is described below as implemented using multiple elements, further examples may implement the same function using a single element or a single processing entity. It is further understood that the terms “include,” “including,” “comprise,” and/or “comprising,” when used, describe the presence of the specified features, integers, steps, operations, processes, elements, components, and/or a group thereof, but do not exclude the presence or addition of one or more other features, integers, steps, operations, processes, elements, components and/or a group thereof.

In the following description, specific details are set forth, but examples of the technologies described herein may be practiced without these specific details. Well-known circuits, structures, and techniques have not been shown in detail to avoid obscuring an understanding of this description. “An example/example,” “various examples/examples,” “some examples/examples,” and the like may include features, structures, or characteristics, but not every example necessarily includes the particular features, structures, or characteristics.

Some examples may have some, all, or none of the features described for other examples. “First,” “second,” “third,” and the like describe a common element and indicate different instances of like elements being referred to. Such adjectives do not imply that the element item so described must be in a given sequence, either temporally or spatially, in ranking, or any other manner. “Connected” may indicate elements are in direct physical or electrical contact with each other and “coupled” may indicate elements co-operate or interact with each other, but they may or may not be in direct physical or electrical contact.

As used herein, the terms “operating,” “executing,” or “running” as they pertain to software or firmware in relation to a system, device, platform, or resource are used interchangeably and can refer to software or firmware stored in one or more computer-readable storage media accessible by the system, device, platform, or resource, even though the instructions contained in the software or firmware are not actively being executed by the system, device, platform, or resource.

The description may use the phrases “in an example/example,” “in examples/examples,” “in some examples/examples,” and/or “in various examples/examples,” each of which may refer to one or more of the same or different examples. Furthermore, the terms “comprising,” “including,” “having,” and the like, as used with respect to examples of the present disclosure, are synonymous.

It should be noted that the example schemes disclosed herein are applicable for/with any operating system and a reference to a specific operating system in this disclosure is merely an example, not a limitation.

Hybrid computing platform refers to a computing architecture combining two or more types of processing cores within the same system-on-chip or processor package. Typically, these cores differ in performance and power consumption characteristics, with one type (a first core type) optimized for high-performance, compute-intensive tasks, and another (a second core type) optimized for energy efficiency and lower performance workloads. This split between performance-oriented cores and efficiency-oriented cores can be known as, respectively, as P/E cores, big/little cores, or performant/efficient cores depending on the architecture. However, this disclosure is not limited to any particular architecture as it is relevant to all hybrid platforms with multiple core types.

When VMs are run on hybrid platforms, CPU resources, including performance and efficiency cores, are allocated at VM initialization. While virtual CPU pinning restricts a VM to specific CPUs, merely fixing vCPUs to individual core types statically may not yield the best performance for VM workloads.

In previous approaches, vCPUs were statically pinned to host performance and/or efficiency cores, which can lead to suboptimal performance on hybrid platforms without considering the application thread characteristics. vCPU allocation is often based on empirical data, and in its absence, VMs start with a single vCPU, requiring a shutdown and restart to adjust the count. This approach's drawback is that it doesn't tailor the allocation of various core types to the VM's workload type, such as compute-intensive or lightweight tasks. As a result, performance and/or efficiency cores may be overallocated, not meeting the VM's optimal needs. Moreover, the system only allows for static vCPU creation, lacking the capability for dynamic adjustment.

The concepts, methods, and architecture described herein leverage workload hints from VMs and hardware-guided scheduler (HGS) classification from hardware feedback interface (HFI), feeding this data into an artificial intelligence (AI) Prediction Logic within the Virtual Machine Monitor (VMM). This logic dynamically calculates the necessary performance and efficiency cores for the VMs. Consequently, VMs can dynamically adjust their vCPU count and allocation, ensuring optimal use of hybrid physical CPU resources and maintaining a balanced vCPU-to-pCPU ratio.

In some examples, hardware-guided scheduling information may be provided by the underlying platform to indicate runtime characteristics of executing threads or workloads. Such guidance may include classifications relating to latency sensitivity, throughput optimization, or energy efficiency, and can be used by the virtual machine monitor (VMM) or host operating system to make informed resource allocation decisions. One example of such a mechanism is Intel's Hardware-Guided Scheduler Plus (HGS+), though similar features may exist in other architectures under different terminology.

The proposed technique leverages workload hints from the VM (running application threads) and HGS classification hints from HFI. In some implementations, the HGS classification is stored as a bit in the CPUID register (e.g., CPUID register leaf 07H, sub-leaf 2, bit position 3). This bit indicates hardware-generated state information the VMM uses for optimal allocation decisions. These hints are fed into an AI prediction system based on a Bayesian Model. This system calculates the necessary number of performance and/or efficiency physical cores for each VM and optimally adjusts the vCPU-to-pCPU ratio (vCPU balancing) to maximize overprovisioning benefits. The innovative aspect of this approach integrates software and hardware hints to form an intelligent layer for dynamic ratio mapping, a capability not found in current technologies.

The innovative aspect of the proposed approach lies in integrating hardware and software hints/telemetry to optimize power and performance dynamically. Currently, no existing solution achieves this dynamically, offering a unique competitive advantage.

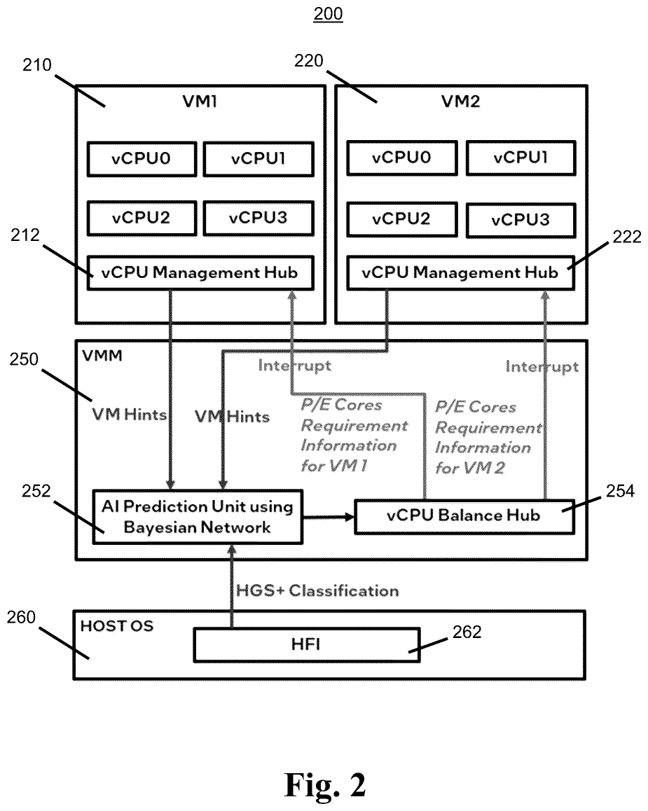

The overall flow and components involved in dynamically determining the number of performance and/or efficiency for each VM using AI Prediction Unit using Bayesian Network and the corresponding number of vCPU requirements are detailed below. FIG. 2 shows a high-level flow diagram of the disclosed technique.

The benefits of the proposed technique deliver multiple benefits, including VMs dynamically receiving optimal hybrid CPU resources tailored to workload hints and OS load, enhanced battery life for VM scenarios through dynamic allocation of performance and efficiency cores using both hardware and software telemetry; real-time thread characteristic data provided by a hardware feedback interface. One example of such a mechanism is Intel's Enhanced Hardware Feedback Interface (EHFI), though similar functionality may be available on other architectures. Further benefits include improved CPU resource efficiency so to fewer CPU cycles are spent while performance increases, enhanced performance, minimal computational overhead from AI processes, reduced VM exits caused by idle vCPU threads, and power savings from optimal CPU resource use.

For validation, management, and debugging purposes, the presence of the proposed technique may be confirmed in various ways: by monitoring the ratio of pinned virtual CPUs to physical CPUs; by reading a dedicated CPUID feature flag that advertises support for the functionality; by examining the interfaces defined between VM and VMM; by collecting Kernal-based VM (KVM) traces with the Linux trace-cmd utility (periodically exporting per-vCPU data and noting increases or decreases in the number of active vCPUs), and by consulting any published interface documentation.

The trace-cmd command interacts with the Ftrace tracer built inside the Linux kernel. This command can be used to generate KVM traces. The traces need to be generated at regular intervals, and the traces for each vCPU should be read. If there is a change in the number of vCPUs and the count has been modified (increased/decreased), this indicates that this proposed technique is used.

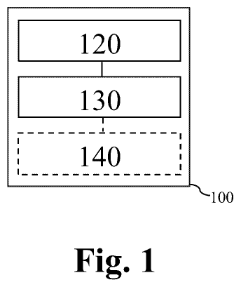

FIG. 1 illustrates a block diagram of an example of an apparatus 100 or device 100. The processing circuitry 130 is configured to allocate a plurality of virtual processors to a virtual machine, VM, wherein the VM is executing a workload and running on a host, the host comprising a processing circuitry comprising a plurality of processing cores of a first performance category and a plurality of processing cores of a second performance category. The processing circuitry 130 is configured to assign each of the plurality of virtual processors to either a processing core of the first performance category or a processing core of the second performance category. The processing circuitry 130 is configured to dynamically re-assign at least one of the virtual processors assigned to a processing core of the second performance category to a processing core of the first performance category based on a measurement of the virtual machine and/or on a measurement of the host running the VM. By dynamically moving selected vCPUs from lower-performance (efficiency) cores to higher-performance cores only when workload or host-state measurements justify it, the apparatus may boost VM responsiveness when needed while avoiding the constant power draw of permanently running on the high-performance cores.

The apparatus 100 comprises circuitry configured to provide the functionality of the apparatus 100. For example, the apparatus 100 of FIG. 1 comprises interface circuitry 120, processing circuitry 130 and (optional) storage circuitry 140. For example, the processing circuitry 130 may be coupled with the interface circuitry 120 and optionally with the storage circuitry 140.

For example, the processing circuitry 130 may be configured to provide the functionality of the apparatus 100, in conjunction with the interface circuitry 120. For example, the interface circuitry 120 is configured to exchange information, e.g., with other components inside or outside the apparatus 100 and the storage circuitry 140. Likewise, the device 100 may comprise means that is/are configured to provide the functionality of the device 100.

The components of the device 100 are defined as component means, which may correspond to, or be implemented by, the respective structural components of the apparatus 100. For example, the device 100 of FIG. 1 comprises means for processing 130, which may correspond to or be implemented by the processing circuitry 130, means for communicating 120, which may correspond to or be implemented by the interface circuitry 120, and (optional) means for storing information 140, which may correspond to or be implemented by the storage circuitry 140. In the following, the functionality of the device 100 is illustrated with respect to the apparatus 100. Features described in connection with the apparatus 100 may thus likewise be applied to the corresponding device 100.

In general, the functionality of the processing circuitry 130 or means for processing 130 may be implemented by the processing circuitry 130 or means for processing 130 executing machine-readable instructions. Accordingly, any feature ascribed to the processing circuitry 130 or means for processing 130 may be defined by one or more instructions of a plurality of machine-readable instructions. The apparatus 100 or device 100 may comprise the machine-readable instructions, e.g., within the storage circuitry 140 or means for storing information 140.

The interface circuitry 120 or means for communicating 120 may correspond to one or more inputs and/or outputs for receiving and/or transmitting information, which may be in digital (bit) values according to a specified code, within a module, between modules or between modules of different entities. For example, the interface circuitry 120 or means for communicating 120 may comprise circuitry configured to receive and/or transmit information.

For example, the processing circuitry 130 or means for processing 130 may be implemented using one or more processing units, one or more processing devices, or any means for processing, such as a processor, a computer, or a programmable hardware component being operable with accordingly adapted software. In other words, the described function of the processing circuitry 130 or means for processing 130 may as well be implemented in software, which is then executed on one or more programmable hardware components. Such hardware components may comprise a general-purpose processor, a Digital Signal Processor (DSP), a microcontroller, etc.

For example, the storage circuitry 140 or means for storing information 140 may comprise at least one element of the group of a computer-readable storage medium, such as a magnetic or optical storage medium, e.g., a hard disk drive, a flash memory, Floppy-Disk, Random Access Memory (RAM), Read Only Memory (ROM), Programmable Read Only Memory (PROM), Erasable Programmable Read Only Memory (EPROM), an Electronically Erasable Programmable Read Only Memory (EEPROM), or a network storage.

In some examples, the measurement of the host running the VM comprises at least one of a state of the VM, a priority class of the VM, a number of processing cores used by the VM, a processing state of the workload executed by the VM, an intensity of the workload executed by the VM, a priority class of the VM. The priority class may be low, normal, or high. Capturing these VM-level signals lets the VMM assign higher-performance cores only when the workload truly needs them. This may result in boosted responsiveness while conserving energy.

In some examples, measurement of the host running the VM comprises at least one of a processing circuitry usage, power consumption, thermal state, memory utilization, or a hardware guided scheduler. Host-level telemetry may enable proactive boosts or throttles that reduce thermal hotspots and overall power draw without sacrificing throughput.

In some examples, the processing circuitry 130 is further configured to determine a probability value for performing the re-assigning based on the measurement of the virtual machine and/or on a probability value measurement of the host running the VM. For example, the host firmware may report a 0.65 probability that the thermal budget will be exceeded within 100 ms. A probabilistic decision metric may avoid unnecessary migrations, preserving system stability while still reacting to real contention.

In some examples, the probability is determined by a machine learning algorithm. Machine-learning prediction adapts over time to workload patterns. This may yield progressively smarter allocation choices and higher aggregate performance.

In some examples, the probability is determined by a Bayesian network. A Bayesian model captures conditional dependencies among metrics. This may give more accurate contention forecasts and lower latency under bursty loads.

In some examples, the measurement of the virtual machine and/or the measurement of the host running the VM are input into the Bayesian network to determine the probability value for performing the re-assigning. VM or host data input may keep the model self-tuned and ensure optimal allocation decisions as conditions evolve.

In some examples, the processing circuitry 130 is further configured to re-assign at least one of the virtual processors if the determined probability value exceeds a first threshold. For example, the first threshold may be 0.49 (or 0.59, 0.69, 0.75, etc.). A threshold may prevent oscillation between core types and stabilize performance while responding quickly to genuine workload surges.

In some examples, the number of virtual processors re-assigned from a processing core of the second performance category to a processing core of the first performance category is based on the determined probability value. Scaling reassignment with probability may avoid over-provisioning and balance performance benefits against power costs.

In some examples, the number of virtual processors re-assigned from a processing core of the second performance category to a processing core of the first performance category is determined based on a lookup table. A pre-computed lookup table may yield deterministic, low-latency decisions with negligible runtime overhead. Table 1 illustrates a sample lookup table for probability-based virtual processor reassignment:

TABLE 1

| Bayesian Probability (P) | Additional Performance Core Allocation |
|---|---|
| 0.0 to 0.49 | 0% |
| 0.5 to 0.59 | 20% |
| 0.6 to 0.74 | 50% |
| ≥0.75 | 90% |

For example, if the Bayesian network produces a probability value of 0.58 and the current allocation is four performance cores, the system calculates 20% of four cores (0.8), rounding up to one additional performance coreperformance core for a total allocation of five performance cores.”

In some examples, the processing cores of the first performance category have higher performance and higher power consumption than cores of the second performance category. Selective use of these higher-power cores may maximize peak performance only when needed and extend battery life on portable platforms.

In some examples, the processing cores of the first performance category have at least one of a higher clock speed, larger cache size, or more robust and more execution units than cores of the second performance category. Deploying richer cores during intensive phases may shorten execution time and improve user-perceived responsiveness.

In some examples, the processing circuitry 130 is further configured to obtain the measurement of the virtual machine and/or the measurement of the host running the VM. Metric collection may eliminate manual tuning and enable rapid deployment across diverse hardware configurations.

In some examples, the re-assigning of the least one virtual processor of the VM from a processing core of the second performance category to a processing core of the first performance category further comprises to re-assign at least one of a virtual processor of a second VM from a processing core of the first performance category to a processing core of second performance category. The second VM, comprising a second plurality of virtual processors, executes a second workload and runs on the host. Coordinated cross-VM redistribution may mitigate noisy-neighbor effects (i.e., unwanted performance degradation in one VM caused by resource consumption of another VM sharing the same host) and deliver predictable quality-of-service for all tenants on the host.

Further details and aspects are mentioned in connection with the examples described below. The example shown in FIG. 1 may include one or more optional additional features corresponding to one or more aspects mentioned in connection with the proposed concept or one or more examples described below (e.g., FIGS. 2-5).

FIG. 2 illustrates a high-level flow diagram of the proposed technique. Specifically, FIG. 2 is a layered block diagram of a virtualized computing system 200 that implements the AI-driven core-balancing technique. At the top layer are two guest virtual machines—VM1 210 and VM2 220 each containing four virtual processor threads (vCPU0-vCPU3) and a guest-kernel vCPU-management hub 212, 222. Beneath the VMs sits the virtual-machine monitor (VMM) 250. Inside the VMM, an AI-prediction unit 152 (implemented as a Bayesian network) receives: VM hints supplied periodically by each vCPU-management hub 212, 222. HGS classification data emitted by a hardware-feedback interface (HFI 262) in the host operating system (host OS 260).

Using these inputs, the prediction unit 252 computes how many performance-class (P) and efficiency-class (E) cores each VM should receive. The recommendation is forwarded to a vCPU-balance hub 254, which reconciles the requests across all VMs. The balance hub returns performance and/or efficiency core requirement messages to the corresponding vCPU-management hubs 212, 222, delivered via interrupt lines. Each guest then enables or disables vCPUs accordingly. The technique employs AI-driven dynamic allocation and balancing of CPU resources to enhance VM performance on hybrid platforms. The technique unfolds in four phases: initialization, vCPU Management, AI Prediction, and vCPU Balance.

During the initialization phase of the VM, vCPU threads are created based on the number of online cores available in the system or different allocation policies for individual VMs. Each VM's vCPUs are pinned with any Physical CPUs (performance and/or efficiency). The topology of the pCPUs would be exposed to the vCPUs. Each vCPU is assigned a priority. vCPUs mapped to performance cores would be set to high priority, and vCPUs mapped to efficiency cores would be set to low priority

The vCPU Management Hub resides in each VM in the guest kernel module. The daemon is loaded automatically after the guest OS gets initialized. In addition, it sets up a communication channel with the AI Prediction Unit to determine the number of vCPUs required for each VM. vCPU Management Hub wakes up at regular time intervals and then goes to sleep. During the awake period, the information below is provided to the AI Prediction Unit.

Hints from VM are provided to the AI Prediction Unit inside VMM from the vCPU Management Hub. The hints include whether the VM is active or suspended, the class of service assigned to its threads, the current process state (running, uninterruptible sleep, interruptible sleep, stopped, or zombie), the concurrency of the workload, and the current number of performance cores assigned to the VM.

A VM process can be in the following states: a process control block monitors its activity. While these processes exist, they can be in one of the five possible states: Running or Runnable; Uninterruptible Sleep; Interrupted able Sleep (Wait/locking); and Stopped/Zombie.

Concurrency of workload means information about the number of cores used concurrently by the process/thread in a VM.

The AI Prediction unit residing in the VMM may also receive hints of the HGS classification of the threads from the host OS. In addition, the vCPU Management Hub is to receive the performance and/or efficiency core allocation from the AI Prediction Unit/vCPU Balance Hub via VMM and disable/enable the vCPUs of that VM by setting the sched_core_priority value. The scheduler in the VM will schedule the process/threads based on the priority value. If the priority is zero, no threads will be scheduled in that vCPU, and it will be moved to an idle state.

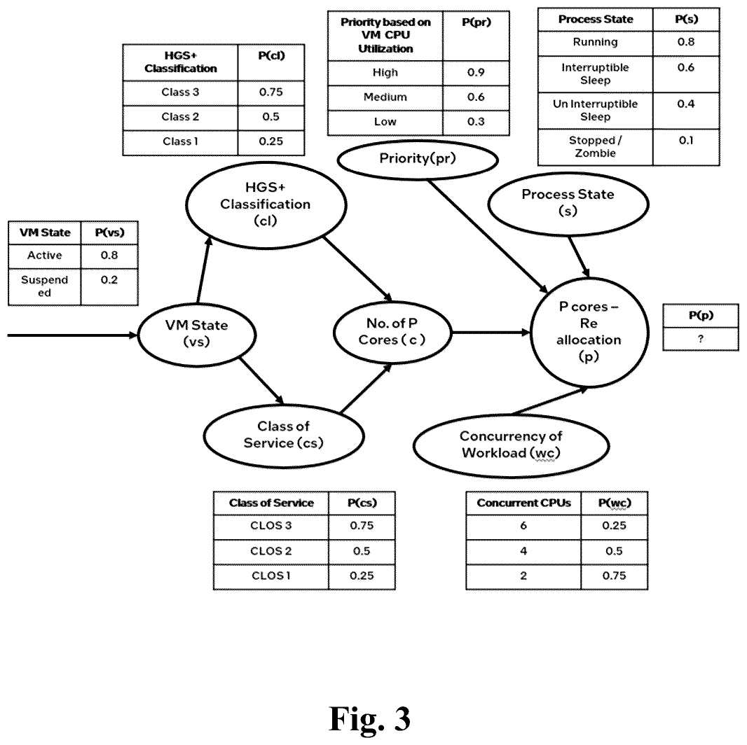

The procedure for the AI Prediction Unit using a Bayesian Network is as follows: First, the unit fetches the hints for each VM via VMM during the start of the workload execution and HGS classification information. Second, the unit preprocesses the data for each VM based on important components and identifies the vital features needed for the model. Third, a Bayesian network is created based on the identified features for calculating the probabilities. A sample Bayesian network is provided in FIG. 3. Fourth, based on the probability value calculated by the Bayesian network, the reallocation of performance cores will be calculated. If the probability value is greater than 0.5, performance cores reallocation is needed. Fifth, a lookup table for probability values calculates the performance cores and efficiency cores.

The lookup table creation is based on the following logic. If the value is between 0.5-0.6, the allocation will be 20% extra of the current performance core allocation. If it's between 0.6-0.75, 50% extra of the current allocation of performance cores, and if it's above 0.75, almost 90% extra allocation of cores (value between 0 to 0.4 will not get any reallocation. Also, the output of the reallocation would be taken to the highest integer value).

For example, if the probability from the Bayesian graph is 0.58, it should reallocate 20% of the current allocation. Assuming the current allocation is four performance cores for the VM, 20% is 0.8. In other words, the unit should add one more performance core for that VM.

Sixth, once the AI prediction unit projects the performance cores allocation, the efficiency cores would be proportionately moved/assigned to the VMs where the vCPU Balance Hub reduces the performance core share.

Seventh, the calculated performance and/or efficiency cores will be updated to the vCPU Management Hub located in each of the VMs.

Eight, if more VMs become candidates for the reallocation of performance cores, the priority (pr) will be whose VM CPU utilization will be considered. Only the VM with high CPU utilization will be considered, and other VMs will be taken into the next cycle.

FIG. 3 illustrates an example of a Bayesian model with probability tables. To demonstrate how the model operates, consider the following input values: the process state is Running (prior probability 0.8); the VM state is Active (0.8); the workload is using two concurrent CPUs (0.75); the thread's HGS classification is Class 1 (0.25); the VM-utilization priority is High (0.9); and the VM is already assigned a high number of performance cores (c).

Given these conditions, the model calculation of probability based on Bayesian mode may comprise the following:

$$P ( ρ / P ( C = high number of cores ) , P ( cl = C lass 1 ) , P ( c s = CLOS 3 ) , P ( s = Running ) , P ( pr = High ) , P ( vs = Active ) , P ( w c = 2 ) )$$

Where P(p) is the probability indicating the threshold that determines whether reallocation of performance cores should occur given the following conditions: the number of performance cores(C) is high, HGS classification (cl) as class 1, class of service (CLOS) as CLOS 3, process state(s) as running, priority(pr) as High, VM state (vs) as active, workload concurrency as 2. The probability value will be calculated based on the above equation from the posterior probability and conditional probability tables.

These calculations are not compute-intensive (it doesn't involve mathematical convolutions or matrix-intensive calculations), so the overhead is very low.

Returning to the vCPU Balance Hub of FIG. 2. The AI Prediction Unit will provide the number of performance cores recommended for each Virtual Machine. This information would be fed to the vCPU Balance Hub. With the prediction of the number of performance cores, this center's original allocation of performance and/or efficiency would be modified to match the total number of vCPUs. i.e., if the original allocation of performance cores is one and efficiency cores is three and if the AI Prediction unit determines performance core count to be two, the one efficiency core adjustment would be made. The vCPU Balance Hub output will provide the exact number of performance and/or efficiency cores required for that VM and the vCPUs to be marked for not being used. This information will be passed on to the vCPU Management Hub via the communication channel. Based on this requirement, the vCPUs will be pinned.

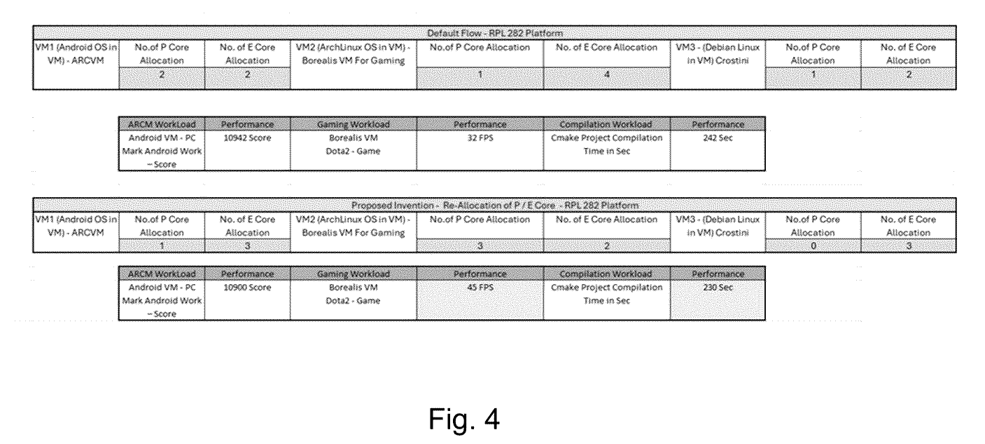

FIG. 4 illustrates an example of results of the proposed technique. It compares a baseline, fixed core-allocation scheme with the disclosed AI-driven P/efficiency core re-balancing on a three-VM hybrid system. Under static allocation each VM keeps a preset mix of high-performance (P) and efficiency (E) cores, whereas the invention shifts performance cores toward the VM that is momentarily CPU-bound (a gaming workload) and back-fills the others with efficiency cores. In the proof-of-concept run this dynamic swap markedly raised the gaming VM's frame rate, trimmed the compile-time workload by a few percent, and left the productivity VM essentially unchanged. This demonstrates that the Bayesian scheduler may boost overall throughput and user-perceived responsiveness without increasing the total performance core budget.

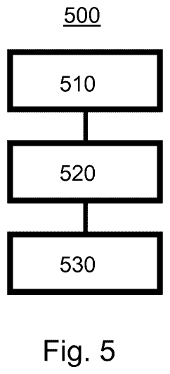

FIG. 5 shows a flowchart of a method for allocating and balancing CPU resources for VMs. The method 500 may include allocating 510 a plurality of virtual processors to a virtual machine, VM, wherein the VM is executing a workload and running on a host, the host comprising a processing circuitry comprising a plurality of processing cores of a first performance category and a plurality of processing cores of a second performance category. The method further comprises assigning 520 each of the plurality of virtual processors to either a processing core of the first performance category or to a processing core of the second. The method further comprises dynamically re-assigning 530 at least one of the virtual processors assigned to a processing core of the second performance category to a processing core of the first performance category based on a measurement of the virtual machine and/or a measurement of the host running the VM.

More details and aspects of the method are explained in connection with the proposed technique or one or more examples described above, e.g., with reference to FIG. 1. The method may comprise one or more additional optional features corresponding to one or more aspects of the proposed technique, or one or more examples described above.

In the following, some examples of the proposed concept are presented:

An example (e.g., example 1) relates to an apparatus comprising interface circuitry, machine-readable instructions, and processing circuitry to execute the machine-readable instructions to allocate a plurality of virtual processors to a virtual machine, VM, wherein the VM is executing a workload and running on a host, the host comprising a processing circuitry comprising a plurality of processing cores of a first performance category and a plurality of processing cores of a second performance category, assign each of the plurality of virtual processors either to a processing core of the first performance category or to a processing core of the second performance category, and dynamically re-assign at least one of the virtual processors assigned to a processing core of the second performance category to a processing core of first performance category, based on a measurement of the virtual machine and/or on a measurement of the host running the VM.

Another example (e.g., example 2) relates to a previous example (e.g., example 1) or to any other example, further comprising that the measurement of the host running the VM comprises at least one of a state of the VM, a priority class of the VM, a number of processing cores used by the VM, a processing state of the workload executed by the VM, an intensity of the workload executed by the VM, a priority class of the VM.

Another example (e.g., example 3) relates to a previous example (e.g., one of the examples 1 to 2) or to any other example, further comprising that measurement of the host running the VM comprise at least one of a processing circuitry usage, power consumption, thermal state, memory utilization or a hardware guided scheduler.

Another example (e.g., example 4) relates to a previous example (e.g., one of the examples 1 to 3) or to any other example, further comprising that the processing circuitry is further to execute the machine-readable instructions to determine a probability value for performing the re-assigning based on the measurement of the virtual machine and/or on a probability value measurement of the host running the VM.

Another example (e.g., example 5) relates to a previous example (e.g., example 4) or to any other example, further comprising that the probability is determined by a machine learning algorithm.

Another example (e.g., example 6) relates to a previous example (e.g., one of the examples 4 to 5) or to any other example, further comprising that wherein the probability is determined by a Bayesian network.

Another example (e.g., example 7) relates to a previous example (e.g., example 6) or to any other example, further comprising that the measurement of the virtual machine and/or the measurement of the host running the VM are input into the Bayesian network to determine the probability value for performing the re-assigning.

Another example (e.g., example 8) relates to a previous example (e.g., one of the examples 4 to 7) or to any other example, further comprising that the processing circuitry is further to execute the machine-readable instructions to perform the re-assigning of the at least one of the virtual processors if the determined probability value exceeds a first threshold.

Another example (e.g., example 9) relates to a previous example (e.g., one of the examples 4 to 8) or to any other example, further comprising that the number virtual processors which are re-assigned from a processing core of the second performance category to a processing core of first performance category is based on the value of the determined probability.

Another example (e.g., example 10) relates to a previous example (e.g., example 9) or to any other example, further comprising that the number virtual processors which are re-assigned from a processing core of the second performance category to a processing core of first performance category is determined based on a lookup table.

Another example (e.g., example 11) relates to a previous example (e.g., one of the examples 1 to 10) or to any other example, further comprising that the processing cores of the first performance category have higher performance and higher power consumption than cores of the second performance category.

Another example (e.g., example 12) relates to a previous example (e.g., one of the examples 1 to 11) or to any other example, further comprising that the processing cores of the first performance category have at least one of a higher clock speed, larger cache size, or more robust and more execution units than cores of the second performance category.

Another example (e.g., example 13) relates to a previous example (e.g., one of the examples 1 to 12) or to any other example, further comprising that the processing circuitry is further to execute the machine-readable instructions to obtain the measurement of the virtual machine and/or the measurement of the host running the VM.

Another example (e.g., example 14) relates to a previous example (e.g., one of the examples 1 to 13) or to any other example, further comprising that the re-assigning of the least one virtual processor of the VM from a processing core of the second performance category to a processing core of first performance category further comprises to re-assign at least one of a virtual processor of a second VM from a processing core of the first performance category to a processing core of second performance category, wherein the second VM, comprising a second plurality of virtual processors, is executing a second workload and running on the host.

An example (e.g., example 15) relates to a method comprising allocating a plurality of virtual processors to a virtual machine, VM, wherein the VM is executing a workload and running on a host, the host comprising a processing circuitry comprising a plurality of processing cores of a first performance category and a plurality of processing cores of a second performance category, assigning each of the plurality of virtual processors either to a processing core of the first performance category or to a processing core of the second performance category, and dynamically re-assigning at least one of the virtual processors assigned to a processing core of the second performance category to a processing core of first performance category, based on a measurement of the virtual machine and/or on a measurement of the host running the VM.

An example (e.g., example 16) relates to an apparatus comprising processor circuitry configured to allocate a plurality of virtual processors to a virtual machine, VM, wherein the VM is executing a workload and running on a host, the host comprising a processing circuitry comprising a plurality of processing cores of a first performance category and a plurality of processing cores of a second performance category, assign each of the plurality of virtual processors either to a processing core of the first performance category or to a processing core of the second performance category, and dynamically re-assign at least one of the virtual processors assigned to a processing core of the second performance category to a processing core of first performance category, based on a measurement of the virtual machine and/or on a measurement of the host running the VM.

An example (e.g., example 17) relates to a device comprising means for processing for allocating a plurality of virtual processors to a virtual machine, VM, wherein the VM is executing a workload and running on a host, the host comprising a processing circuitry comprising a plurality of processing cores of a first performance category and a plurality of processing cores of a second performance category, assigning each of the plurality of virtual processors either to a processing core of the first performance category or to a processing core of the second performance category, and dynamically re-assigning at least one of the virtual processors assigned to a processing core of the second performance category to a processing core of first performance category, based on a measurement of the virtual machine and/or on a measurement of the host running the VM.

Another example (e.g., example 18) relates to a non-transitory machine-readable storage medium including program code, when executed, to cause a machine to perform the method of example 15.

Another example (e.g., example 19) relates to a computer program having a program code for performing the method of example 15 when the computer program is executed on a computer, a processor, or a programmable hardware component.

Another example (e.g., example 20) relates to a machine-readable storage including machine readable instructions, when executed, to implement a method or realize an apparatus as claimed in any pending examples.

An example (e.g., example 21) relates to a system comprising a host computing platform, comprising processing circuitry including a plurality of processing cores of a first performance category and a plurality of processing cores of a second performance category; a virtual machine monitor (VMM) executing on the host computing platform, configured to manage assignment of resources of the host computing platform; and at least one virtual machine (VM) executing a workload on the host computing platform, the VM comprising a plurality of virtual processors managed by the VMM, wherein the VMM comprises machine-readable instructions which, when executed by the processing circuitry, cause the VMM to: allocate the plurality of virtual processors to the VM; assign each of the plurality of virtual processors either to a processing core of the first performance category or to a processing core of the second performance category; and dynamically re-assign at least one of the virtual processors previously assigned to a processing core of the second performance category to a processing core of the first performance category based on a measurement of the virtual machine and/or on a measurement of the host computing platform running the VM.

The aspects and features described in relation to a particular one of the previous examples may also be combined with one or more of the further examples to replace an identical or similar feature of that further example or to additionally introduce the features into the further example.

Examples may further be or relate to a (computer) program including a program code to execute one or more of the above methods when the program is executed on a computer, processor or other programmable hardware component. Thus, steps, operations or processes of different ones of the methods described above may also be executed by programmed computers, processors or other programmable hardware components. Examples may also cover program storage devices, such as digital data storage media, which are machine-, processor- or computer-readable and encode and/or contain machine-executable, processor-executable or computer-executable programs and instructions. Program storage devices may include or be digital storage devices, magnetic storage media such as magnetic disks and magnetic tapes, hard disk drives, or optically readable digital data storage media, for example. Other examples may also include computers, processors, control units, (field) programmable logic arrays ((F) PLAs), (field) programmable gate arrays ((F) PGAs), graphics processor units (GPU), application-specific integrated circuits (ASICs), integrated circuits (ICs) or system-on-a-chip (SoCs) systems programmed to execute the steps of the methods described above.

It is further understood that the disclosure of several steps, processes, operations or functions disclosed in the description or claims shall not be construed to imply that these operations are necessarily dependent on the order described, unless explicitly stated in the individual case or necessary for technical reasons. Therefore, the previous description does not limit the execution of several steps or functions to a certain order. Furthermore, in further examples, a single step, function, process or operation may include and/or be broken up into several sub-steps, -functions, -processes or -operations.

If some aspects have been described in relation to a device or system, these aspects should also be understood as a description of the corresponding method. For example, a block, device or functional aspect of the device or system may correspond to a feature, such as a method step, of the corresponding method. Accordingly, aspects described in relation to a method shall also be understood as a description of a corresponding block, a corresponding element, a property or a functional feature of a corresponding device or a corresponding system.

As used herein, the term “module” refers to logic that may be implemented in a hardware component or device, software or firmware running on a processing unit, or a combination thereof, to perform one or more operations consistent with the present disclosure. Software and firmware may be embodied as instructions and/or data stored on non-transitory computer-readable storage media. As used herein, the term “circuitry” can comprise, singly or in any combination, non-programmable (hardwired) circuitry, programmable circuitry such as processing units, state machine circuitry, and/or firmware that stores instructions executable by programmable circuitry. Modules described herein may, collectively or individually, be embodied as circuitry that forms a part of a computing system. Thus, any of the modules can be implemented as circuitry. A computing system referred to as being programmed to perform a method can be programmed to perform the method via software, hardware, firmware, or combinations thereof.

Any of the disclosed methods (or a portion thereof) can be implemented as computer-executable instructions or a computer program product. Such instructions can cause a computing system or one or more processing units capable of executing computer-executable instructions to perform any of the disclosed methods. As used herein, the term “computer” refers to any computing system or device described or mentioned herein. Thus, the term “computer-executable instruction” refers to instructions that can be executed by any computing system or device described or mentioned herein.

The computer-executable instructions can be part of, for example, an operating system of the computing system, an application stored locally to the computing system, or a remote application accessible to the computing system (e.g., via a web browser). Any of the methods described herein can be performed by computer-executable instructions performed by a single computing system or by one or more networked computing systems operating in a network environment. Computer-executable instructions and updates to the computer-executable instructions can be downloaded to a computing system from a remote server.

Further, it is to be understood that implementation of the disclosed technologies is not limited to any specific computer language or program. For instance, the disclosed technologies can be implemented by software written in C++, C#, Java, Perl, Python, JavaScript, Adobe Flash, C#, assembly language, or any other programming language. Likewise, the disclosed technologies are not limited to any particular computer system or type of hardware.

Furthermore, any of the software-based examples (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, cable (including fiber optic cable), magnetic communications, electromagnetic communications (including RF, microwave, ultrasonic, and infrared communications), electronic communications, or other such communication means.

The disclosed methods, apparatuses, and systems are not to be construed as limiting in any way. Instead, the present disclosure is directed toward all novel and nonobvious features and aspects of the various disclosed examples, alone and in various combinations and subcombinations with one another. The disclosed methods, apparatuses, and systems are not limited to any specific aspect or feature or combination thereof, nor do the disclosed examples require that any one or more specific advantages be present or problems be solved.

Theories of operation, scientific principles, or other theoretical descriptions presented herein in reference to the apparatuses or methods of this disclosure have been provided for the purposes of better understanding and are not intended to be limiting in scope. The apparatuses and methods in the appended claims are not limited to those apparatuses and methods that function in the manner described by such theories of operation.

The following claims are hereby incorporated in the detailed description, wherein each claim may stand on its own as a separate example. It should also be noted that although in the claims a dependent claim refers to a particular combination with one or more other claims, other examples may also include a combination of the dependent claim with the subject matter of any other dependent or independent claim. Such combinations are hereby explicitly proposed unless it is stated in the individual case that a particular combination is not intended. Furthermore, features of a claim should also be included for any other independent claim, even if that claim is not directly defined as dependent on that other independent claim.

What is claimed is:

1. An apparatus comprising interface circuitry, machine-readable instructions, and processing circuitry to execute the machine-readable instructions to:
allocate a plurality of virtual processors to a virtual machine (VM) wherein the VM is executing a workload and running on a host, the host comprising a processing circuitry comprising a plurality of processing cores of a first performance category and a plurality of processing cores of a second performance category;
assign each of the plurality of virtual processors either to a processing core of the first performance category or to a processing core of the second performance category; and
dynamically re-assign at least one of the virtual processors assigned to a processing core of the second performance category to a processing core of first performance category, based on a measurement of the virtual machine and/or on a measurement of the host running the VM.

2. The apparatus of claim 1, wherein the measurement of the host running the VM comprises at least one of a state of the VM, a priority class of the VM, a number of processing cores used by the VM, a processing state of the workload executed by the VM, an intensity of the workload executed by the VM, a priority class of the VM.

3. The apparatus of claim 1, wherein measurement of the host running the VM comprise at least one of a processing circuitry usage, power consumption, thermal state, memory utilization or a hardware guided scheduler.

4. The apparatus of claim 1, wherein the processing circuitry is further to execute the machine-readable instructions to determine a probability value for performing the re-assigning based on the measurement of the virtual machine and/or on a probability value measurement of the host running the VM.

5. The apparatus of claim 4, wherein the probability is determined by a machine learning algorithm.

6. The apparatus of claim 4, wherein the probability is determined by a Bayesian network.

7. The apparatus of claim 6, wherein the measurement of the virtual machine and/or the measurement of the host running the VM are input into the Bayesian network to determine the probability value for performing the re-assigning.

8. The apparatus of claim 4, wherein the processing circuitry is further to execute the machine-readable instructions to perform the re-assigning of the at least one of the virtual processors if the determined probability value exceeds a first threshold.

9. The apparatus of claim 4, wherein the number virtual processors which are re-assigned from a processing core of the second performance category to a processing core of first performance category is based on the value of the determined probability.

10. The apparatus of claim 9, wherein the number virtual processors which are re-assigned from a processing core of the second performance category to a processing core of first performance category is determined based on a lookup table.

11. The apparatus of claim 1, wherein the processing cores of the first performance category have higher performance and higher power consumption than cores of the second performance category.

12. The apparatus of claim 1, wherein the processing cores of the first performance category have at least one of a higher clock speed, larger cache size, or more robust and more execution units than cores of the second performance category.

13. The apparatus of claim 1, wherein the processing circuitry is further to execute the machine-readable instructions to obtain the measurement of the virtual machine and/or the measurement of the host running the VM.

14. The apparatus of claim 1, wherein the re-assigning of the least one virtual processor of the VM from a processing core of the second performance category to a processing core of first performance category further comprises
to re-assign at least one of a virtual processor of a second VM from a processing core of the first performance category to a processing core of second performance category,
wherein the second VM, comprising a second plurality of virtual processors, is executing a second workload and running on the host.

15. A method comprising:
allocating a plurality of virtual processors to a virtual machine (VM) wherein the VM is executing a workload and running on a host, the host comprising a processing circuitry comprising a plurality of processing cores of a first performance category and a plurality of processing cores of a second performance category;
assigning each of the plurality of virtual processors either to a processing core of the first performance category or to a processing core of the second performance category; and
dynamically re-assigning at least one of the virtual processors assigned to a processing core of the second performance category to a processing core of first performance category, based on a measurement of the virtual machine and/or on a measurement of the host running the VM.

16. A non-transitory machine-readable storage medium including program code, when the program code is executed on a computer, a processor, or a programmable hardware component, causes the computer, the processor, or the programmable to perform the method of claim 15.

17. A system comprising:
a host computing platform, comprising processing circuitry including a plurality of processing cores of a first performance category and a plurality of processing cores of a second performance category;
a virtual machine monitor (VMM) executing on the host computing platform, configured to manage assignment of resources of the host computing platform; and
at least one virtual machine (VM) executing a workload on the host computing platform, the VM comprising a plurality of virtual processors managed by the VMM,
wherein the VMM comprises machine-readable instructions which, when executed by the processing circuitry, cause the VMM to:
allocate the plurality of virtual processors to the VM;
assign each of the plurality of virtual processors either to a processing core of the first performance category or to a processing core of the second performance category; and
dynamically re-assign at least one of the virtual processors previously assigned to a processing core of the second performance category to a processing core of the first performance category based on a measurement of the virtual machine and/or on a measurement of the host computing platform running the VM.
